(19) United States
(12) Patent Application Publication
(10) Pub. No.: US 2011/0054199 A1
(43) Pub. Date: Mar. 3, 2011

(54) Methods for extracting nutrients, drugs and toxins from a sample, and apparati for same

(75) Inventors: Ameer Y. Taha, Toronto (CA); Adam H. Metherel, Waterloo (CA); Kenneth D. Stark, Waterloo (CA)

(73) Assignee: CERTO LABS, INC., TORONTO (CA)

(21) Appl. No.: 12/589,297

(22) Filed: Oct. 21, 2009

Related U.S. Application Data
(60) Provisional application No. 61/238,355, filed on Aug. 31, 2009.

(51) Int. Cl. C11B 1/10; B01D 11/00; G01N 1/28; C11B 13/00

(52) U.S. Cl. 554/20; 554/206; 429/527

(57) ABSTRACT

Provided is a novel method for extracting nutrients, toxins and drugs from a solid sample, comprising adding a solvent such as hexane and isopropanol to said sample, subjecting the sample and solvent to ultrasonic energy, subjecting the sample and solvent to heat, then removing the solvent liquid fraction from what remains of the sample.

Also provided is an apparatus for performing said method in an automated manner.

This patent claims priority from U.S. provisional patent 61/238,355 filed Aug. 31, 2009, which is incorporated herein in its entirety.

### FIELD OF THE INVENTION

The invention relates to methods of extracting nutrients, drugs and toxins from food, tissue, blood and seed.

### BACKGROUND OF THE INVENTION

The consumption of nutrients such as dietary fat has significant consequences on human health. For example, omega-3 polyunsaturated fatty acids, such as eicosapentaenoic acid (EPA) and doxosahexaenoic acid (DHA) are believed to provide significant cardiovascular benefits, support optimal neurological development, and protect against various neurological disorders, including depression, Alzheimer's disease and attention deficit disorder. Other dietary fats have significant negative effects—for example, industrially generated so-called trans fatty acids, saturated fats and cholesterol are believed to dramatically increase the risk of cardiovascular disease and the risk of death associated with them.

Similarly, the contamination of food samples with drugs or toxins is associated with cancer, teratogenesis, liver failure and metabolic syndrome. Food additives such as antibiotic drugs are routinely used in fish farming to promote the growth of aquatic creatures such as shrimp. Over time, however, these antibiotics tend to accumulate in seafood, and may pose a significant danger for human health.

Constant and accurate monitoring of the food supply is therefore crucial.

Current analytical methods for the determination of levels of nutrients, toxins or drugs in foods are time-consuming and a significant financial burden in the increasing number of jurisdictions which require labeling of such information on food products, or the quantification of analytes for quality control purposes. To determine the levels of toxins, nutrients or drugs in a sample, one must extract the desired toxin, nutrient or drug from the sample, using onerous, expensive, and time consuming methods.

Various methods are known for extracting nutrients such as fatty acids and cholesterol, and drugs/toxins from food or other biomass. Techniques include direct extraction with various solvents, heating, pressure waves generated by electric arcs, direct saponification via KOH and ethanol, sonication, freezing and grinding, and bead mills. Other methods include pressure disruption, enzymatic extraction, treatment with a polar organic solvent, salt, or precipitating agent, temperature changes, binding of specific analytes that trigger color changes, liquid chromatography, gas chromatography, supercritical fluid chromatography, immunoassay methods, radiolabelling assays. Many such methods are taught, for example, in US 2006/0099693, US 2005/0170479, U.S. Pat. Nos. 6,022,748, 5,801,026, which are incorporated herein by reference.

There are several currently acceptable protocols used by industry, universities, and research institutions for the extraction and quantification nutrients such as total lipids containing fatty acids from food samples. For instance, protocols approved by the Association of Official Analytical Chemists (AOAC)¹ or the International Organization for Standardization method² are typically used by industry laboratories to determine fatty acid composition for food labeling purposes. The Folch method³, a time-tested method developed in 1957, is still the standard within most research institutions and universities.

Unfortunately, these standardized methods, for nutrients, toxins and drugs, are expensive and onerous, requiring approximately 4-14 hours to undertake, from start to finish. The expense comes both from this time requirement, and the large solvent volumes required to perform the extractions (for the ISO and AOAC methods).

One prior art method for the extraction of phenols⁴, ginsenosides⁵, anthraquinones⁶, and polycyclic aromatic hydrocarbons⁷⁸, as well as fatty acids and other lipids⁹, involves the use of ultrasonic energy.

Though prior art ultrasound-assisted lipid extraction methods decrease the sample extraction time, sometimes to as low as one hour,^{2,10,11,12} these methods require large sample and solvent volumes, and are not quantitative. For instance, Cravotto et al.¹¹ also examined ultrasound-assisted extraction with small volumes of sample and solvents, but this resulted in determinations of fatty acid content that was qualitative and not quantitative, making it difficult to evaluate the utility of such methods for extracting fatty acids from samples.

It would be desirable to have a less expensive and/or more rapid method for the extraction and/or quantitative determination of nutrients, toxins and drugs such as fatty acids, cholesterol and antibiotics, in a sample, such as a food sample.

### BRIEF DESCRIPTION OF FIGURES

FIG. 1 represents an automated apparatus for performing the method described herein, according to one aspect of the present invention.

FIG. 2 represents total lipid dry weight of extracted fatty acids for various methods of extraction (varying solvent, and sonication time) as compared to the Folch standard fatty acid extraction method. A: 2:1 (v:v) chloroform:methanol; B: 3:2 (v:v) hexane:isopropanol; C: 1:1 (v:v) diethyl ehter:petroleum ether; D: hexane. Bars represent means with error bars representing SD. n=4. Bars with different letters are significantly different by Tukey's HSD post hoc procedure (p<0.05) after a significant F-value by one-way ANOVA (p<0.05).

FIG. 3 represent mass spectra of alpha-linoleic acid methyl ester (18:3n−3) obtained from (A) NIST 05 library database; (B) standard 24 h Folch extraction; and (C) ultrasound-assisted extraction in 3:2 hexane:isopropanol for 20 minutes at 100% amplitude.

FIG. 4 represents malonaldehyde concentrations in standard and sonication for 20 minutes at 100% probe amplitude lipid extractions in various solvents. Bars represent means±SD, n=4. Bars with different letters are significantly different by independent t-test (p<0.05).

FIG. 5 shows cholesterol concentration in eggs, expressed as mg/g, following extraction with the AOAC method or ultrasound and heat for 20 and 15 minutes respectively.

FIG. 6 shows sulfonamide antibiotic concentration in shrimp samples as mg/g, following extraction with the AOAC method or ultrasound and heat for 20 and 15 minutes respectively.

### SUMMARY OF THE INVENTION

According to one embodiment of the present invention is provided a method for extracting nutrients, toxins and drugs from a solid sample, comprising: (a) adding hexane and isopropanol or preferred solvent to said sample; (b) subjecting the sample, hexane, and isopropanol to ultrasonic energy; (c) subjecting the sample, hexane, and isopropanol to heat; and (d) removing the hexane and isopropanol liquid fraction from what remains of the sample; wherein the hexane and isopropanol liquid fraction contains the extracted nutrient, toxin or drug.

According to a second embodiment of the present invention is provided a “one pot” method for extracting/isolating a nutrient, toxin or drug, and/or optionally derivatizing from a sample, comprising: (a) adding hexane and isopropanol or preferred solvent to said sample; (b) subjecting the sample, hexane, and isopropanol to ultrasonic energy; (c) subjecting the sample, hexane, and isopropanol to heat; (c1) optionally derivatizing the nutrient, toxin or drug now contained within the hexane/isopropanol fraction; (d) removing the hexane and isopropanol liquid fraction, containing the extracted, compound, from what remains of the sample; and optionally (e) evaporating the hexane and isopropanol to isolate the extracted nutrient or drug in its naïve or derivitized form.

According to a further aspect of the present invention, the method further comprises (e) evaporating the hexane and isopropanol to isolate the extracted nutrient, toxin or drug.

According to one aspect, the sample from which the nutrients, toxin or drugs are extracted is a food item. According to another aspect, the sample is a seed. According to a further aspect, the sample is a blood sample. According to yet a further aspect, the sample is a tissue sample.

According to certain aspects of the invention, step (b) and (c) can occur simultaneously, or either one can occur before the other.

According to one aspect, the lipid is one or more fatty acid, for example, myristic acid, palmitic acid, palmitoleic acid, stearic acid, arachidic acid, betenic acid, oleic acid, linoleic acid, alpha-linolenic acid, arachidonic acid and/or docosahexaenoic acid.

According to one aspect of the invention, the method also comprises adding a salt to said sample, for example, sodium chloride, to separate the aqueous phase. In one aspect, the salt is added before step (b).

In certain embodiments, the sample is subjected to ultrasonic energy for between 5 to 30 minutes, for example, about 20 minutes, or 20 minutes, using an ultrasonic probe immersed in the hexane and isopropanol, said ultrasonic probe set at a medium intensity, for example, an intensity of between 20% and 100%, such as an intensity of about 60%.

In alternative embodiments, the sample can be subjected to ultrasound from below the vessel containing the sample, using an ‘ultrasound horn’ for example, or it can be immersed in an ultrasound chamber.

According to one aspect, step (c) comprises heating said sample to a temperature of between 85 and 115° C., for example, about 100° C., or 100° C., for between 10 and 20 minutes, and for example, about 15 minutes.

According to a further aspect of the invention, the sample can be capped under nitrogen gas prior to heating to minimize the oxidation of heat-sensitive compounds.

According to a further embodiment of the present invention is provided an apparatus for the extraction of nutrients, toxins and drugs from a sample, comprising: (a) containing means for containing said sample such as a vessel; (b) an ultrasonic probe, having two positions, a first position wherein the ultrasonic probe is outside of the containing means, a second position wherein the ultrasonic probe is within the containing means; (c) a heating element capable of heating the containing means; (d) a temperature sensor capable of (directly or indirectly) sensing the temperature within the containing means; (e) a microprocessor controller coupled to the heating element, the ultrasonic probe, and the temperature sensor, and capable of controlling the duration and/or intensity of said ultrasonic probe and heating element; and (f) a switch, toggle, or button for activating the microprocessor controller.

According to one aspect, the containing means is capable of containing a disposable container containing said sample.

According to a further aspect, the apparatus further comprises: (a) a fluid reservoir capable of containing isopropanol and hexane; (b) a fluid pump coupled to said fluid reservoir, capable of transferring a fluid from said fluid reservoir to the containing means; wherein the fluid pump is coupled to the microprocessor controller, and the microprocessor controller is capable of controlling the amount of fluid transferred from the fluid reservoir to the containing means.

According to a further aspect, the apparatus further comprises: (a) a gas reservoir capable of containing compressed nitrogen gas, and capable of transferring a gas from said gas reservoir to the containing means; (b) a gas flow control means for controlling gas flow from the gas reservoir to the containing means; wherein the gas flow control means is coupled to the microprocessor controller, and the microprocessor controller is capable of controlling the amount of gas transferred from the gas reservoir to the containing means.

According to a further aspect, the apparatus further comprises: (a) a gas inlet, capable of receiving a gas from an external compressed gas line; (b) an internal gas line, linking said gas inlet to the containing means; (c) a gas flow control means for controlling gas flow from the gas inlet to the containing means; wherein the gas flow control means is coupled to the microprocessor controller, and the microprocessor controller is capable of controlling the amount of gas transferred from the gas inlet to the containing means.

### DETAILED DESCRIPTION

The present inventors have surprisingly found a new method for extracting nutrients, toxins and drugs such as lipids, fatty acids, cholesterol and antibiotics from a solid sample. The new method provides significant time and cost reduction over the prior art methods while maintaining similar or better precision. Since the new method is standardized, automated extraction processes are enabled, using the new method; as such, the present inventors also disclose a new machine that utilizes the new method for standardized, and optionally automated and high throughput, nutrient, toxin and drug extraction.

The present inventors show, below, that this new method for extracting nutrients and toxins/drugs is quantitatively accurate, and in many cases quantitatively more precise than the prior art, known, and industry standard methodologies.

In one embodiment, the new method is as follows. A sample from which it is desired to extract lipids is placed in a test tube. A hexane/isopropanol mixture is added to the sample. The hexane/isopropanol mixture can be a 1:1 (vol/vol) mixture of hexane/isopropanol; other ratios of hexane to isopropanol will also work, to varying degrees of efficacy.

The test tube or vessel containing the hexane/isopropanol mixture and the sample is then subjected to ultrasonic energy, by inserting an ultrasonic probe in the test tube. A variety of ultrasonic energies can be used; we have found that a mid-range frequency and amplitude of ultrasonic energy, for a standard sized ⅛″ microprobe with a maximum amplitude of 240 μm, works well, though other frequencies and amplitudes also work. The sample is thus subjected to ultrasonic energy. We have found that subjecting the sample to ultrasonic energy for 5-30 minutes, for example, 10-30 minutes, or about 20 minutes, or about 15 minutes, works well, though other durations will also work. We noted that extremely low amplitudes of ultrasonic energy, and extremely short (for example, 30 seconds) durations of action did not work as well. Paradoxically, we also found that extremely high durations of action (for example, 6 hours) also did not work as well.

The test tube containing the hexane/isopropanol is then heated, to 80-120° C., for example, to about 100° C. The heating can take place in a standard heating bath, though an oven, or any other type of heating apparatus may be used (for example, the heating element in the automated apparatus, described below). We found that heating for a duration of 5-30 minutes, for example, 10-30 minutes, or 10-20 minutes, or about 15 minutes, works well, though other temperatures and durations of action also worked. As might be expected, insufficiently low temperature or time (for example, 35° C., or 30 seconds) did not work as well. Paradoxically, however, excessively high temperature or time (for example, 250° C. or 3 days) also did not work as well.

Optionally, the heating step may take place before, instead of after, the ultrasonic treatment; the heating step and the ultrasonic step may also take place simultaneously, resulting in an even greater time advantage (i.e. the method is even quicker than the prior art methods when the two steps are combined in this manner). We have found that there is no significant consequence to the order of these two steps: for example, they may overlap in part only, with one of the two steps occurring before and during, or after and during, the other step. Where different time frames are used, the steps can occur before, during, and after one another—for example, if 10 minutes of ultrasonic energy, and 15 minutes of heat, are desired, one can subject the sample to 10 minutes of ultrasonic energy, followed by 15 minutes of heat; 15 minutes of heat followed by 10 minutes of ultrasonic energy; or 15 minutes of heat during which the sample is subjected to ultrasonic energy for 10 minutes (with the additional five minutes of heat occurring either before, after, or both before and after the ultrasonic energy treatment).

After the heat and ultrasonic energy treatment, the nutrients, toxins or drugs can be found in the hexane/isopropanol solvent fraction. Optionally, at this stage, the test tube may be shaken, or the sample disrupted in some other manner such as agitation or vortexing. Also optionally, the test tube may be lightly spun in a centrifuge to better isolate the sample from the fluid, or it can sit for a few hours until the phases separate.

At this point, the extracted compounds are in the hexane/isopropanol fraction. To make a quantitative determination of the amount of nutrient or drug in the sample, the hexane/isopropanol fraction can be removed from the test tube, and the hexane/isopropanol can be evaporated using known means; what remains is the compound fraction, which can be analyzed utilizing known methods in the art (such as gas chromatography, high pressure liquid chromatography, or mass spectrometry). Alternatively, if appropriate for the analytic method used, the extracted compound fraction can be analyzed directly from the hexane/isopropanol by using spectrophotometry.

The Inventors have also determined that if it is desired to derivatize the compounds in the sample, this can be done while the compounds are in the hexane/isopropanol mix or following evaporation of the hexane/isopropanol. This can even be done in situ, in a “one-pot” process, wherein the sample is still pelleted at the bottom of the test tube, or on the supernatant after it is optionally transferred to another tube and dried.

The inventors have found that the method described herein works very well with food items, even food items that are traditionally very difficult to extract lipids from, such as flax seeds. The method is also appropriate for extracting lipids from other seeds, blood samples (to determine the amount of lipid in the blood sample), for example, whole blood or plasma, and from a tissue that has been removed from a living being. The method is very good at extracting myristic acid, palmitic acid, palmitoleic acid, stearic acid, arachidic acid, behenic acid, oleic acid, linoleic acid, and alpha-linolenic acid. It is also good for extracting other longer-chain polyunsaturated fatty acids such as eicosapentaenoic acid, docosahexaenoic acid and arachidonic acid.

Optionally, a salt, such as sodium chloride, can be added to the mixture, and appears to aid in the separation of the lipids for instance, into the hexane/isopropanol layer. The salt can be added at any time in the process, but has maximal effect when added before the heating or ultrasonic treatment.

Also optionally, the inventors have found that capping the test tube with inert gas, such as hydrogen gas, prior to heating and/or prior to ultrasonic treatment, reduces the oxidation of the lipids in the sample. This results in more accurate readings of the kind and quantity of lipid in the sample.

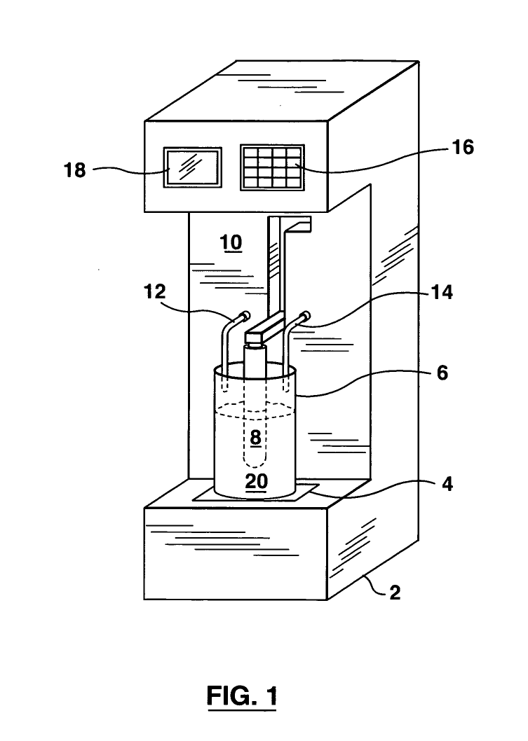

As can be readily understood by a person of skill in the art, the method taught herein can be automated, through the use of a dedicated apparatus, as seen in FIG. 1. The dedicated apparatus comprises a base comprising a heating element 4, in which the test tube 6 containing the sample (not shown) can be placed. The apparatus also comprises an ultrasonic probe 8, affixed to the back 10 of the apparatus, and which can be moved from one, lower position (as shown) wherein the probe 8 is primarily inside the test tube 6, and a second, higher position wherein the probe 8 is outside and, as shown, above, the test tube 6. Optionally and as shown, the apparatus may also have a fluid aperture 12 which is connected to a fluid reservoir housed within the apparatus (not shown) or connected to the apparatus, via a fluid pump (not shown). The fluid aperture 12 is flexible and may be placed into the test tube 6 by a user. The apparatus may also have a gas aperture 14 which is connected to a gas reservoir housed within the apparatus (not shown) or connected to the apparatus, via a gas flow control means. Optionally, the apparatus may also have a test tube cleaning element (not shown), to clean the test tube between samples. Typically the test tube cleaning element will clean the test tube while the probe 8 is in the second, higher position.

The apparatus has a microprocessor (not shown) for controlling the heating element 4, the movement and activation of the ultrasonic probe 8, and optionally the release of fluid from the fluid aperture 12 and of gas from the gas aperture 14. The microprocessor is controlled by the user through control panel 16, and the status of the operation of the unit can be monitored by the user through LCD screen 18.

Using the automated apparatus is as follows: A user would add a sample to a test tube 6 and place the test tube 6 within the apparatus as shown. The user would then enter the following parameters into the control panel 16: heating temperature and time, ultrasonic energy intensity and time, amount of solvent 20, and whether N2 is bubbled.

The machine would then, automatically, (1) add the correct amount of isopropanol/hexane solvent 20 through fluid aperture 12, by controlling the fluid pump; (2) bubble an appropriate amount of nitrogen gas into the top of the test tube; (3) activate the heating element 4 for an appropriate amount of time, with temperature setting controlled through a thermostatic sensor (not shown) imbedded into the heating element 4 and monitored by the microprocessor; (4) lower the ultrasonic probe 8 into the test tube 6; (5) activate the ultrasonic probe 8 for the appropriate amount of time and intensity; (6) raise the ultrasonic probe 8; then, optionally (7) signal to the user that the lipids have been extracted. Optionally, (8) the user would then remove the extracted lipids and replace the test tube, which would (again, optionally) be washed with the test tube cleaning element.

### EXAMPLES

The method of the present invention is exemplified by the following examples, which should not be seen as limiting, but, rather, exemplifying the invention.

### Example 1

### Lipid Extraction Using Various Solvents and Ultrasound Intensities

Lipids were extracted from samples of 25 mg of ground flaxseed (Bob's Red Mill Natural Foods, Inc., Milwaukee, Oreg., USA). Lipids were extracted using the novel method; lipids were also extracted utilizing various other methods for comparison. All extractions were done [in triplicate]. All extractions were done using 25 mg of ground flaxseed, added to 3 ml of solvent. All extraction solvents included 50 μg/ml of butylated hydroxytoluene (Sigma-Aldrich, St. Louis, Mo., USA) as an antioxidant; ethyl esters of nonadecanoic acid (19:0) (Nuchek Prep, Elysian, Minn., USA) was added as an internal standard, since flaxseed is known to not contain said fatty acid.

The control (24-h unassisted, or “Folch” method) was the standard for comparison. 25 mg of ground flaxseed was added to 3 ml of 2:1 (v:v) chloroform:methanol. Total lipids were extracted into the chloroform:methanol by allowing the sample to sit at room temperature for 24 hours.

The control group was compared to 20 different experimental groups, as follows: Experimental extractions were done using four different solvent mixtures: 2:1 chloroform:methanol, 3:2 hexane:isopropanol, 1:1 diethyl ether:petroleum ether; and hexane. Each of these four different solvent mixtures were subjected to a different level of sonication, as follows: 20 minutes at 20% intensity; 5 minutes@100% intensity; 10 minutes at 100% intensity; 20 minutes at 60% intensity; and 20 minutes at 100% intensity, using a Misonix™ ultrasonic processor S-4000 (Misonix inc., Farmingdale N.Y.). The S-4000 operated at a 20 kHz electrical signal, supplied to the converter, equipped with a ⅛″ (3.2 mm) microprobe having a maximal amplitude of 240 μm. The sonication probe was placed directly into the solvent containing the flaxseed and sonicated for 5, 10 or 20 minutes at 20%, 60% or 100% of maximal probe amplitude (240 μm).

Samples were reconstituted with the appropriate amount of solvent if evaporation of the solvent was noticeable. Solvent evaporation was particularly evident in the 20 minute sonication groups, for some of the samples.

Following sonication, an aqueous buffer of either sodium phosphate (for the chloroform:methanol groups) or sodium sulfate (for the hexane:isopropanol and diethyl ether: petroleum ether groups) was added to the extraction solvents; the samples were then gently mixed and centrifuged. The organic layer was collected and dried under nitrogen in a pre-weighed test tube to allow for dry lipid weight determinations. Total lipids were dissolved in hexane and stored at −80° C. until fatty acid analyses were completed.

Fatty acid methyl esters were prepared from total lipid extracts with 14% boron trifluoride in methanol (Pierce Chemicals, Rockford, Ill., USA) and hexane, with convectional heating at 95° C. for 1 hour. The organic layer containing the fatty acid methyl esters were collected for analysis on a Varian 3900 gas chromatograph equipped with a DB-FFAP 15 m×0.10 mm i.d.×0.10 μm film thickness, nitroterephthalic acid modified, polyethylene glycol, capillary column (J&W Scientific from Agilent Technologies, Mississauga, ON), with hydrogen as the carrier gas. 2 μl samples were introduced by a Varian CP-8400 autosampler into the injector heated to 250° C. with a split ratio of 200:1. Initial temperature was 150° C. with a 0.25 minute hold, followed by a 35° C./minute ramp up to 200° C., an 8° C./minute ramp up to 225° C. with a 3.2 minute hold, then an 80° C./minute ramp up to 245° C. followed by a 15 minute hold.

Flame ionization detector temperature was 300° C. with air and nitrogen make-up gas flow rates of 300 ml/min and 25 ml/min, respectively, and a sampling frequency of 50 Hz.

### Gas Chromatography Mass Spectrometry (GCMS) Analysis

Fatty acids for the various groups (as described above) were analyzed on a Varian 3800 GC coupled to a Varian 4000 MS (GCMS) with a quadrupole ion trap (Varian Canada Inc., Mississauga ON) in External EI mode as described previously.¹³ Briefly, the GCMS was equipped with a DB-FFAP 30 m×0.25 mm i.d.×25 μm film thickness capillary column (J&W Scientific from Agilent Technologies, Mississauga ON), interfaced directly onto the ion source with helium as carrier gas. Initial column temperature was 50° C. with a 1 minute hold, followed by a 30° C./minute ramp up to 130° C., an 8° C./minute ramp up to 175° C., a 1° C./minute ramp up to 210° C., a 30° C./minute ramp up to 345° C., all followed by a 30 minute hold. Additional temperature settings were as follows: injector, 260° C.; transfer line, 250° C.; source 180° C.; manifold, 50° C. Mass ranges between 50 m/z to 400 m/z were examined with target ion counts of 20,000 with a maximum ionization time of 65 μs and an emission current of 25 μA. Each data point was generated by a 3 μScan average resulting in a 0.55 s maximum time scan. Fatty acid mass spectra were cross referenced to the NIST 05 database for identification and confirmation.

### Malonaldehyde Determinations

The concentration of malonaldehyde, a major product of unsaturated fatty acid peroxidation, was determined in the 24-hour standard Folch lipid extraction and in lipid extractions for the four solvents, by a modified thiobarbituric acid reactive species assay¹⁴. Briefly, lipid extracts were dissolved in 55 mM thiobarbituric acid, 3.5M acetic acid, deionized H₂0 and 0.28M sodium dodecyl sulphate and heated in a water bath at 95° C. for 1 hour. Samples were rapidly cooled and 5 ml of 15:1 (v:v) butanol:pyridine and 1 ml of deionized H₂O was added; the samples were then vortexed and centrifuged. The absorbance at a wavelength of 532 nm was measured in the top organic butanol layer on a UV160U Spectrophotometer (Shimadzy, Columbia, Md.) and quantified against a malonaldehyde standard curve.

Dry weight extraction values and qualitative and quantitative values for individual fatty acids were determined and expressed as mean±SD. All statistical analyses were performed with the SPSS System (SPSS Inc., Chicago, Ill.). Various extraction protocols were examined by one-way ANOVA with individual means compared following a significant F-value by the Tukey's Honestly Significant Different (HSD) post hoc procedure. Significance was inferred at p<0.05.

Table 1 shows the quantitative fatty acid profile of flaxseed following ultrasound-assisted extraction in various solvents. Values that were significantly different from the control (Folch) group are marked with an (*). Note that significance, in this case, means that the two methods yielded significantly different results; as such, only methods that are not significantly different from the Control method are deemed interchangable with the control method, and, as such, are useful as alternative methods.

TABLE 1
Quantitative fatty acid profiles of flaxseed, expressed as mg per 25 mg
of flaxseed, following ultrasound-assisted extraction in various solvents

| Fatty | Control | Sonication parameters | | | |
|---|---|---|---|---|---|
| Acid | (Folch) | 5 min, 100% | 10 min, 100% | 20 min, 60% | 20 min, 100% |

Table 1A: 2:1 (v:v) chloroform:methanol

| | | | | | |
|---|---|---|---|---|---|
| 16:0 | 0.50 ± 0.02 | 0.37 ± 0.02* | 0.41 ± 0.03* | 0.44 ± 0.04* | 0.41 ± 0.03* |
| 18:0 | 0.33 ± 0.02 | 0.23 ± 0.01* | 0.25 ± 0.02* | 0.27 ± 0.03* | 0.25 ± 0.02* |
| 18:1n-9 | 2.07 ± 0.07 | 1.57 ± 0.09* | 1.70 ± 0.14* | 1.83 ± 0.20* | 1.62 ± 0.12* |
| 18:2n-6 | 1.45 ± 0.07 | 1.11 ± 0.05* | 1.19 ± 0.09* | 1.29 ± 0.14 | 1.14 ± 0.09* |
| 18:3n-3 | 4.04 ± 0.14 | 3.10 ± 0.15* | 3.34 ± 0.27* | 3.63 ± 0.36 | 3.20 ± 0.27* |
| Total | 8.62 ± 0.31 | 6.48 ± 0.33* | 7.01 ± 0.54* | 7.59 ± 0.77 | 6.74 ± 0.54* |

Table 1B: 3:2 (v:v) hexane:isopropanol

| | | | | | |
|---|---|---|---|---|---|
| 16:0 | 0.50 ± 0.02 | 0.38 ± 0.02* | 0.45 ± 0.03* | 0.45 ± 0.03* | 0.43 ± 0.03* |
| 18:0 | 0.33 ± 0.02 | 0.24 ± 0.01* | 0.28 ± 0.02* | 0.29 ± 0.03 | 0.27 ± 0.02* |
| 18:1n-9 | 2.07 ± 0.07 | 1.63 ± 0.09* | 1.89 ± 0.11 | 1.84 ± 0.06* | 1.87 ± 0.13 |
| 18:2n-6 | 1.45 ± 0.07 | 1.14 ± 0.06* | 1.33 ± 0.06 | 1.32 ± 0.06 | 1.30 ± 0.10 |
| 18:3n-3 | 4.04 ± 0.14 | 3.21 ± 0.18* | 3.72 ± 0.13 | 3.68 ± 0.18 | 3.68 ± 0.26 |
| Total | 8.62 ± 0.31 | 6.72 ± 0.36* | 7.79 ± 0.33 | 7.72 ± 0.36 | 7.68 ± 0.55 |

Table 1C: 1:1 (v:v) diethyl ether:petroleum ether

| | | | | | |
|---|---|---|---|---|---|
| 16:0 | 0.50 ± 0.02 | 0.32 ± 0.02* | 0.38 ± 0.04* | 0.42 ± 0.02* | 0.43 ± 0.01* |
| 18:0 | 0.33 ± 0.02 | 0.21 ± 0.01* | 0.24 ± 0.02* | 0.26 ± 0.01* | 0.27 ± 0.01* |
| 18:1n-9 | 2.07 ± 0.07 | 1.39 ± 0.07* | 1.62 ± 0.14* | 1.78 ± 0.09* | 1.86 ± 0.05* |
| 18:2n-6 | 1.45 ± 0.07 | 0.99 ± 0.05* | 1.15 ± 0.10* | 1.26 ± 0.06* | 1.30 ± 0.03* |
| 18:3n-3 | 4.04 ± 0.14 | 2.73 ± 0.16* | 3.22 ± 0.30* | 3.52 ± 0.15* | 3.61 ± 0.08* |
| Total | 8.62 ± 0.31 | 5.73 ± 0.32* | 6.73 ± 0.59* | 7.36 ± 0.33* | 7.60 ± 0.17* |

Table 1D: hexane

| | | | | | |
|---|---|---|---|---|---|
| 16:0 | 0.50 ± 0.02 | 0.34 ± 0.05* | 0.36 ± 0.02* | 0.39 ± 0.04* | 0.35 ± 0.03* |
| 18:0 | 0.33 ± 0.02 | 0.21 ± 0.03* | 0.22 ± 0.02* | 0.23 ± 0.02* | 0.21 ± 0.01* |
| 18:1n-9 | 2.07 ± 0.07 | 1.42 ± 0.22* | 1.53 ± 0.12* | 1.62 ± 0.15* | 1.47 ± 0.10* |
| 18:2n-6 | 1.45 ± 0.07 | 1.06 ± 0.15* | 1.12 ± 0.08* | 1.21 ± 0.09* | 1.12 ± 0.08* |
| 18:3n-3 | 4.04 ± 0.14 | 3.10 ± 0.40* | 3.30 ± 0.18* | 3.61 ± 0.28 | 3.37 ± 0.27* |
| Total | 8.62 ± 0.31 | 6.24 ± 0.86* | 6.62 ± 0.43* | 7.18 ± 0.59* | 6.62 ± 0.49* |

Values are means ± SD.
n = 4.
*indicates significantly different from Folch controls by Tukey's HSD post hoc procedure (p < 0.05) after a significant F-value by one-way ANOVA (p < 0.05).

### Results

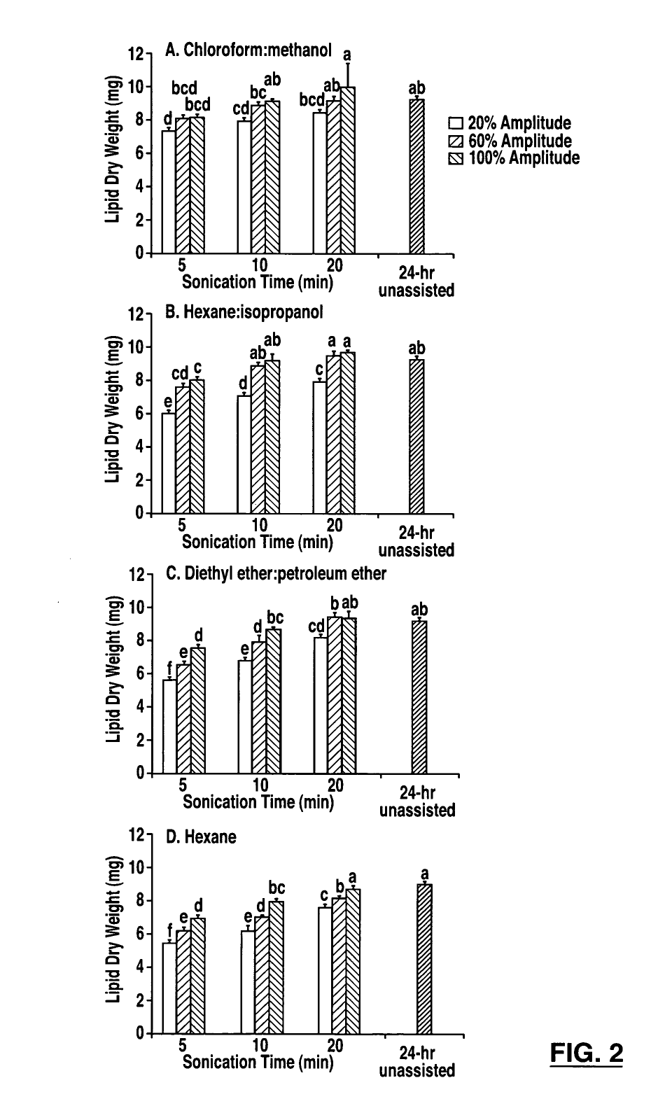

FIG. 2 shows the dry weight of the extracted lipid. A lipid dry weight of 9.25±0.14 mg was determined in 25 mg of ground flaxseed, using the 24-h unassisted (control) (Folch) extraction with 2:1 (v:v) chloroform:methanol. With the ultrasound method, lipid extraction dry weight recovery was maximal at 100% amplitude for 20 minutes with 2:1 (v:v) chloroform:methanol (9.98±1.44 mg). Dry lipid weight recoveries with ultrasound assistance at 100% amplitude for 20 minutes also resulted in high recoveries in 3:2 (v:v) hexane: isopropanol (9.72±0.13 mg), 1:1 (v:v) diethyl ether/petroleum ether (9.46±0.41 mg), and hexane (8.94±0.22 mg). Dry lipid weight recoveries at 60% amplitude for 20 minutes were statistically similar to the Folch control and the 100% amplitude for 20 minutes, in chloroform:methanol (9.17±0.11 mg), hexane:isopropanol (9.49±0.31 mg), and diethyl ether/petroleum ether (9.53±0.18 mg) but not in hexane only (8.37±0.16 mg). This dry weight recovery equivalency to the Folch and the 100%/20 minute groups was also observed at 100% amplitude for 10 minutes in chloroform:methanol (9.11±0.29 mg) and hexane: isopropanol (9.25±0.26 mg).

### Quantitative Fatty Acid Analysis

Fatty acid concentrations in milligrams of fatty acid per 25 milligrams of ground flaxseed were determined using 19:0 ethyl ester as the internal standard in all extractions. Fatty acids with masses greater than 0.05 mg were presented for ultrasound-assisted extractions in the various solvents at 100% amplitude for 5, 10 and 20 minutes as well as at 60% amplitude for 20 minutes. Fatty acids presented included palmitic acid (16:0), stearic acid (18:0), oleic acid (18:1n−9), linoleic acid (18:2n−6) and alpha-linolenic acid (18:3n−3), although mysristic acid (14:0), palmitoleic (16:1n−7), vaccenic acid (18:1n−7), arachidic acid (20:0), eicosenic acid (20:1n−9), behenic acid (22:0), erucic acid (22:1n−9) and lignoceric acid (24:0) were also detected. Individual fatty acid determinations were most similar to the 24-hour standard (Folch) control in the hexane:isopropanol with 10 minutes of ultrasound exposure at 100% amplitude, and with 20 minute exposure at 60 and 100% amplitude.

Ultrasound extractions in chloroform:methanol at 60% amplitude for 20 minutes resulted in a fatty acid profile similar to the control, but palmitic acid, stearic acid and oleic acid were all statistically lower. Fatty acid concentrations were largely significantly lower than the control when diethyl ether: petroleum ether or hexane alone were used as solvent.

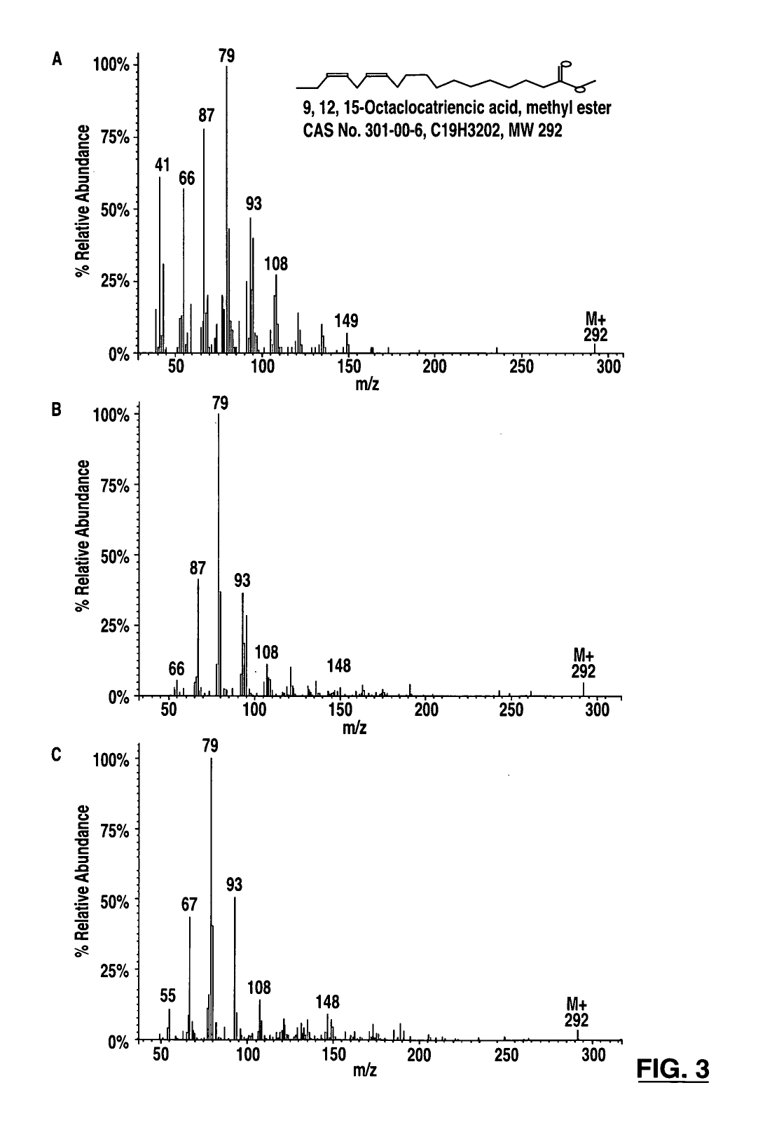

GCMS analyses combined with NIST 05 database searches confirmed the identification of fatty acid methyl esters across extraction techniques, thereby confirming quantitative measures. No differences in the spectra from the standard Folch extraction and the ultrasound-assisted extractions for 20 minutes at 100% amplitude (in hexane:isopropanol) were seen, as demonstrated for alpha-linolenic acid (18:3n−3) in FIG. 3.

### Relative Fatty Acid Analysis

Fatty acid determinations for all extractions, and the results corresponding to Table 1, were presented relative to the percentage weight of total fatty acids, in Table 2, below.

Ultrasound-assisted extraction in various solvents and at varying intensities, alone, yielded similar qualitative, but not quantitative values as compared to the standard Folch procedure. As shown in Table 2, the ultrasound-assisted extractions were more similar to the Folch control group when presented in this relative manner (percentage weight of total fatty acids) rather than when it was presented quantitatively as in Table 1 (mg of fatty acids per 25 mg of flaxseed). The ultrasound-assisted extractions in chloroform:methanol and hexane:isopropanol tended to be more similar to the Folch control as compared to the extractions in diethyl ether:petroleum ether and hexane alone.

TABLE 2
Relative fatty acid profiles of flaxseed, expressed as percentage of total
fatty acids, following ultrasound-assisted extraction in various solvents.

| Fatty | Control | Sonication parameters | | | |
|---|---|---|---|---|---|
| Acid | (Folch) | 5 min, 100% | 10 min, 100% | 20 min, 60% | 20 min, 100% |

Table 2A: 2:1 (v:v) chloroform:methanol

| | | | | | |
|---|---|---|---|---|---|
| 16:0 | 5.79 ± 0.10 | 5.60 ± 0.04 | 5.72 ± 0.18 | 5.64 ± 0.15 | 5.95 ± 0.09* |
| 18:0 | 3.74 ± 0.10 | 3.48 ± 0.03* | 3.56 ± 0.18 | 3.45 ± 0.15* | 3.67 ± 0.06 |
| 18:1n-9 | 23.67 ± 0.28 | 23.72 ± 0.28 | 23.76 ± 0.11 | 23.24 ± 0.16 | 23.69 ± 0.30 |
| 18:2n-6 | 16.57 ± 0.30 | 16.85 ± 0.29 | 16.64 ± 0.29 | 16.46 ± 0.13 | 16.55 ± 0.11 |
| 18:3n-3 | 46.15 ± 0.32 | 46.91 ± 0.11 | 46.75 ± 0.40 | 46.17 ± 0.41 | 46.66 ± 0.17 |

Table 2B: 3:2 (v:v) hexane:isopropanol

| | | | | | |
|---|---|---|---|---|---|
| 16:0 | 5.79 ± 0.10 | 5.52 ± 0.06 | 5.64 ± 0.14 | 5.66 ± 0.18 | 5.52 ± 0.04* |
| 18:0 | 3.74 ± 0.10 | 3.50 0.01 | 3.51 ± 0.06 | 3.64 ± 0.31 | 3.53 ± 0.04 |
| 18:1n-9 | 23.67 ± 0.28 | 23.77 ± 0.13 | 23.80 ± 0.46 | 23.31 ± 0.36 | 24.12 ± 0.08* |
| 18:2n-6 | 16.57 ± 0.30 | 16.66 ± 0.08 | 16.72 ± 0.08 | 16.70 ± 0.29 | 16.67 ± 0.07 |
| 18:3n-3 | 46.15 ± 0.32 | 46.96 ± 0.15 | 46.91 ± 0.72 | 46.49 ± 0.23 | 47.40 ± 0.25* |

Table 2C: 1:1 (v:v) diethyl ether:petroleum ether

| | | | | | |
|---|---|---|---|---|---|
| 16:0 | 5.79 ± 0.10 | 5.46 ± 0.04* | 5.60 ± 0.02* | 5.55 ± 0.07* | 5.59 ± 0.07* |
| 18:0 | 3.74 ± 0.10 | 3.57 ± 0.04* | 3.56 ± 0.10* | 3.54 ± 0.05* | 3.55 ± 0.05* |
| 18:1n-9 | 23.67 ± 0.28 | 23.69 ± 0.19 | 23.58 ± 0.15 | 23.76 ± 0.24 | 24.01 ± 0.24 |
| 18:2n-6 | 16.57 ± 0.30 | 16.88 ± 0.08 | 16.78 ± 0.16 | 16.81 ± 0.17 | 16.83 ± 0.16 |
| 18:3n-3 | 46.15 ± 0.32 | 46.58 ± 0.23 | 46.79 ± 0.21 | 47.02 ± 0.20* | 46.62 ± 0.30 |

Table 2D: hexane

| | | | | | |
|---|---|---|---|---|---|
| 16:0 | 5.79 ± 0.10 | 5.39 ± 0.09* | 5.32 ± 0.07* | 5.31 ± 0.07* | 5.20 ± 0.02* |
| 18:0 | 3.74 ± 0.10 | 3.27 ± 0.06* | 3.24 ± 0.08* | 3.11 ± 0.06* | 3.10 ± 0.04* |
| 18:1n-9 | 23.67 ± 0.28 | 22.24 ± 0.40* | 22.79 ± 0.28* | 21.94 ± 0.18* | 21.90 ± 0.31* |
| 18:2n-6 | 16.57 ± 0.30 | 16.67 ± 0.05 | 16.66 ± 0.07 | 16.45 ± 0.26 | 16.72 ± 0.10 |
| 18:3n-3 | 46.15 ± 0.32 | 48.54 ± 0.47* | 49.30 ± 0.62* | 49.12 ± 0.52* | 50.10 ± 0.30* |

Values are means ± SD.
n = 4.
* = significantly different from 24-hour control (Folch) methodology, using Tukey's HSD post hoc procedure (p < 0.05) after a significant F-value by one-way ANOVA (p < 0.05).

### Lipid Peroxidation

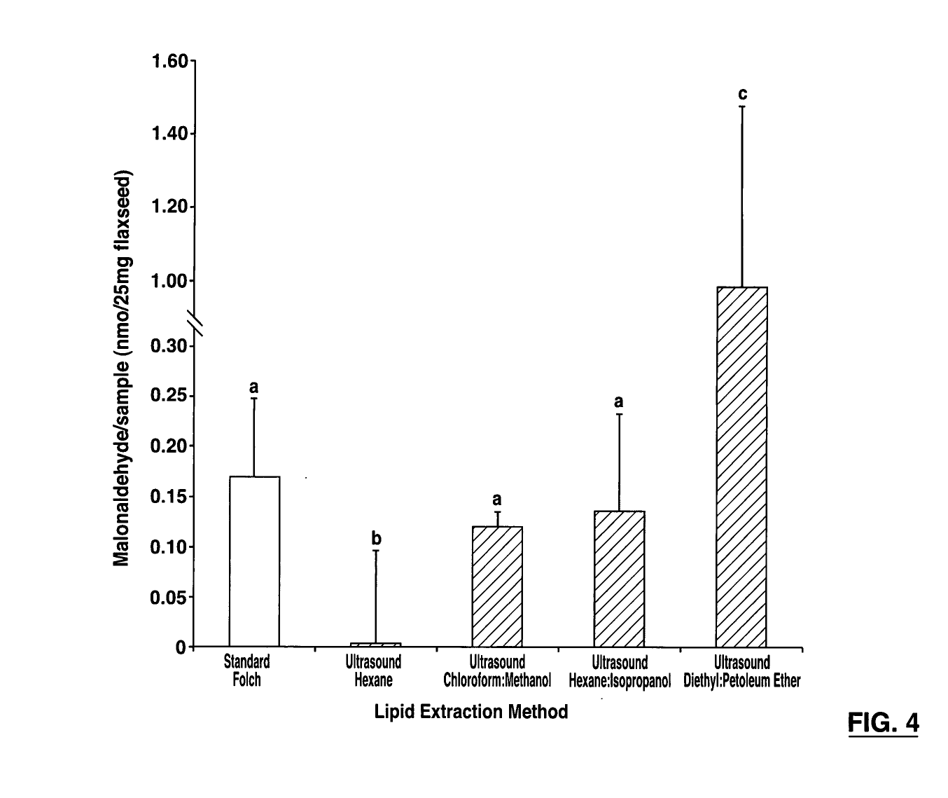

Lipid peroxidation was determined, as estimated by malonaldehyde concentrations, to ensure that qualitative and quantitative differences in fatty acid composition were not related to increased lipid peroxidation. Lipid peroxidation in all groups was relatively low (see FIG. 4). Ultrasound extraction for 20 minutes at 100% amplitude in 3:2 hexane:isopropanol and 2:1 chloroform:methanol yielded similar lipid peroxidation results compared to a standard 24-h Folch extraction; ultrasound extraction in hexane yielded significantly lower and barely detectable lipid peroxidation. Lipid extraction in 1:1 diethyl ether:petroleum ether resulted in significantly higher levels of lipid peroxidation as compared to the 24-h Folch (control) group (0.98±0.49 vs. 0.17±0.09 nmol/25 mg flaxseed extraction). These data suggest that the differences in fatty acid composition were not related to changes in lipid peroxidation, but most likely due to the extraction method.

### Lipid Extraction Using Heat.

As shown in Tables 3-A and 3-B, heat-assisted extraction alone for up to one hour did not yield similar qualitative nor quantitative yields in most cases, as compared to the standard Folch procedure (asterisks indicate significanct differences between the two methods by unpaired t-test comparison, at the 0.05 level). Fatty acid concentrations were generally lower with the heat alone method, as compared to the standard 24-hour Folch method (Table 3-B). This suggests that similar to ultrasound by itself, heat alone is not sufficient to maximize lipid and fatty acid yields.

TABLE 3-A
Qualitative fatty acid profiles of flaxseed, expressed as percentage of total
fatty acids, following extraction with standard 24-hour Folch or heat.

| | | 60 min heat @ |
|---|---|---|
| Fatty Acid | 24 h Folch | 100° C. |
| 14:0 | 0.14 ± 0.03 | 0.1 ± 0.03 |
| 16:0 | 5.79 ± 0.1 | 6.22 ± 0.14* |
| 16:1n-7 | 0.2 ± 0.12 | 0.08 ± 0.04 |
| 18:0 | 3.74 ± 0.1 | 4.4 ± 0.15* |
| 18:1n-9 | 23.74 ± 0.29 | 23.8 ± 0.43 |
| 18:1n-7 | 0.67 ± 0.05 | 1.14 ± 0.08* |
| 18:2n-6 | 16.62 ± 0.29 | 16.3 ± 0.09 |
| 18:3n-3 | 46.27 ± 0.3 | 44.6 ± 0.31* |
| 20:0 | 0.29 ± 0.06 | 0.17 ± 0.04* |
| 20:1n-9 | 0.36 ± 0.13 | 0.16 ± 0.09* |
| 22:0 | 0.32 ± 0.07 | 0.14 ± 0.06* |
| 24:0 | 0.38 ± 0.1 | 0.27 ± 0.16 |
| Total: | 98.54 ± 0.48 | 97.6 ± 0.69* |

TABLE 3-B
Quantitative fatty acid profiles of flaxseed, expressed as mg per 25 mg
of flaxseed, following extraction with standard 24-hour Folch or heat.

| | | 60 min heat @ |
|---|---|---|
| Fatty Acid | 24 h Folch | 100° C. |
| 14:0 | 0.01 ± 0 | 0.01 ± 0* |
| 16:0 | 0.5 ± 0.02 | 0.3 ± 0.01* |
| 16:1n-7 | 0.02 ± 0.01 | 0.01 ± 0* |
| 18:0 | 0.33 ± 0.02 | 0.21 ± 0.01* |
| 18:1n-9 | 2.07 ± 0.07 | 1.20 ± 0.05* |
| 18:1n-7 | 0.06 ± 0 | 0.06 ± 0.01* |
| 18:2n-6 | 1.45 ± 0.07 | 0.80 ± 0.02* |
| 18:3n-3 | 4.04 ± 0.14 | 2.20 ± 0.07* |
| 20:0 | 0.03 ± 0.01 | 0.01 ± 0* |
| 20:1n-9 | 0.03 ± 0.01 | 0.01 ± 0* |
| 22:0 | 0.03 ± 0.01 | 0.01 ± 0* |
| 24:0 | 0.03 ± 0.01 | 0.01 ± 0.01* |
| Total: | 8.62 ± 0.31 | 4.70 ± 0.14* |

### Discussion

The application of 20 minutes of sonication at 60% or heat at 100° C., resulted in the greater lipid yields, particularly when hexane:isopropanol was used as a solvent. The lipid recoveries, however, were not similar to the standard Folch procedure. As indicated in the following example (example 2), the combination of ultrasound at the best frequency, and heat, was tested using hexane/isopropanol as a solvent, and compared to three standard techniques.

### Example 2

### Comparison of Hexane:Isopropanol Ultrasound and Heat Method with Three Standard Methods

The extraction method of Example 1 was combined with heat in order to maximize lipid yield. The combination of hexane:isopropanol, 20 minutes of sonication at 60%, and heat, was compared to three different known industry standard methods for the extraction of lipids from seed—the Folch method, described above, the ISO method, and the AOAC method.

Fatty acids were extracted from ground flaxseed samples (Bob's Red Mill Natural Foods, Inc., Milwaukee, Oreg., USA). For all extractions, 50 μg/ml of butylated hydroxytoluene (Sigma-Aldrich, St. Louis, Mo. USA) was added as an antioxidant to the extraction solvents. Nonadecanoic acid (19:0) ethyl ester (Nuchek Prep, Elysian, Minn. USA) was used as an internal standard.

The ISO procedure was carried out in a Soxhlet apparatus, which consisted of a hot plate which heated a still pot containing a hexane solvent (used to extract total lipids from the sample), and a rotary evaporator that condenses the evaporated solvent into the extraction chamber where 25 mg of flaxseed is packed with cotton into an extraction thimble. The still pot was filled with 100 ml of hexane, and heated to 100° C. on a hot plate for 2 hours. The hexane containing total lipids was transferred to pre-tared flask, and subsequently evaporated under nitrogen for approximately 1 hour. The dry total lipid weight was obtained by weighing the pre-tared flask containing the evaporated total lipid residue. This procedure was repeated with 2 hour extraction times until no change in lipid weight was detected for two consecutive extractions, requiring up to 400 ml of hexane and 8 hours to complete.

The Folch method was performed as described above. Briefly, 3 ml of chloroform:methanol (2:1 v/v) was added to 25 mg of ground flaxseed, and allowed to incubate for 24 hours at room temperature under nitrogen. An aqueous buffer was then added in order to separate the aqueous phase from the non-polar phase containing total lipids. The non-polar phase containing total lipids was then pipetted into pre-tared 8 ml glass screw cap tubes with Teflon® lined caps and dried under nitrogen. The remaining total lipids residue was weighed.

The AOAC method involved the use of acid digestion to degrade proteins that interact with fatty acids, followed by a petroleum ether:diethyl ether (1:1 v/v) extraction. 300 mg of ground flaxseed was weighed in a Mojonnier flask. Acid digestion was used to dissociate the interactions between the lipids and proteins. This was done by adding 100 mg of pyrogallic acid, 10 ml of 8.3M HCI and 2 ml of ethanol to the flask, followed by mixing and heating in a water bath maintained at 75° C. for 40 minutes. The contents of the flask were mixed every 10 minutes, while in the water bath, in order to ensure proper dissolution of the flaxseed particulates. Following acid digestion, the flask was removed from the water bath and allowed to cool to room temperature. Ethanol was then added to fill the bottom of the flask, in order to dilute the acid and terminate the digestion reaction. Total lipids were then extracted by adding 25 ml of diethyl ether to the flask containing the flaxseed and acid diluted in ethanol, and hand shaken for 5 minutes. Petroleum ether (25 ml) was added, and the flask was shaken again for 5 minutes, and allowed to stand for 1 hour to facilitate solvent layer separation. The top layer, a 1:1 diethyl ether:petroleum ether mixture containing total lipids, was transferred to a pre-tared flask and dried under nitrogen. The remaining total lipids residue in the flask was weighed.

The results of these methods were compared to the novel isopropanol:hexane method, as follows. 25 mg of ground flaxseed was added to 3 ml of isopropanol:hexane (2:3 v/v), which included 50 μg/ml of butylated hydroxytoluene (antioxidant).

The flaxseed isopropanol:hexane mixture was subjected to ultrasonic energy using an ultrasonic probe inserted into the solvent for 20 minutes at 60% intensity, using a Misonix™ ultrasonic processor S-4000 (Misonix inc., Farmingdale N.Y.). The S-4000 operated at a 20 kHz electrical signal, supplied to the converter, equipped with a ⅛″ (3.2 mm) microprobe having a maximal amplitude of 240 μm. The sonication probe was placed directly into the solvent containing the flaxseed and sonicated for 20 minutes at 60% of maximal probe amplitude (240 μm).

Samples were reconstituted with the appropriate amount of solvent if evaporation of solvent was noticeable.

Following sonication, an aqueous buffer of sodium sulfate was added to the extraction solvents; the samples were then gently mixed and centrifuged. The organic layer was collected and dried under nitrogen in a pre-weighed test tube to allow for dry lipid weight determinations. Total lipids were dissolved in hexane and stored at −80° C. until fatty acid analyses were completed.

In all groups, ethyl esters of nonadecanoic acid (19:0) (Nuchek Prep, Elysian, Minn., USA) were added as a surrogate internal standard prior to fatty acid derivitization. Fatty acids of total lipid flaxseed extracts were directly methylated with 14% methanolic boron trifluoride (Pierce Chemicals, Rockford, Ill., USA) and hexane by convectional heating at 95° C. for 1 hour. Hexane and water were added to separate the phases, with the upper hexane phase pipetted into a new test-tube, dried under nitrogen and reconstituted in hexane for analysis by gas chromatography.

Fatty acid methyl esters were analyzed on a Varian 3900 gas chromatograph equipped with a DB-FFAP 15 m×0.10 mm i.d.×0.10 μm film thickness nitroterephthalic acid modified polyethylene glycol capillary column (J&W Scientific from Agilent Technologies, Mississauga, ON). Hydrogen was used as a carrier gas. 2 μl samples were injected with a split ratio of 200:1 into the injector port, which was set at 250° C. Initial temperature was 150° C. with a 0.25 minute hold, followed by a 35° C./minute ramp to 200° C., an 8° C./minute ramp up to 225° C., with a 3.2 minute old, and then a 80° C./minute ramp up to 245° C. with a 15 minute hold at the end. The flame ionization detector temperature was 300° C. with air and nitrogen make-up gas flow rates of 300 mL/minute and 25 ml/minute respectively and a sampling frequency of 50 Hz.

Concentration and percent composition of fatty acids were presented as mean±SD. Statistical analysies were performed with SigmaStat v. 3.2 (Systat). The various extraction protocols were examined by one-way ANOVA with individual means compared by the Tukey's post hoc procedure. Statistical significance was set at p<0.05. Fatty acid concentrations following extraction were tabulated in Table 3; Values are means±SD, n=6; values with different letters are significantly different by Tukey's post-hoc procedure after a significant F-value by one-way ANOVA (p<0.05).

Fatty acid concentrations, expressed as mg per 25 mg of weighed flaxseed, are presented in Table 4-A. The sum of total fatty acids, and the individual concentrations of fatty acids did not differ significantly with the different extraction methods. Notably, the precision was higher for the isopropanol/hexane/heat/sonication method, relative to the conventional method. This indicates that the novel isopropanol/hexane/heat/sonication method of the present invention is as good, or better, than any of the other methods currently used interchangably for determination of lipid content.

TABLE 4-A
Quantitative fatty acid profiles of flaxseed, expressed as me per 25
mg of flaxseed, following extraction with Folch, AOAC, ISO, Folch and
novel ultrasound (US) and heat (H) method.

| | | | | US (20 min) + H |
|---|---|---|---|---|
| Name | Folch 24 hr | AOAC | ISO | (15 min) |
| C 14:0 | 0.01 ± 0 | 0.01 ± 0.0 | 0.01 ± 0 | 0.01 ± 0 |
| C 16:0 | 0.5 ± 0.02 | 0.5 ± 0.04 | 0.5 ± 0.03 | 0.48 ± 0.01 |
| C 16:1 | 0.02 ± 0.01 | 0.02 ± 0.0 | 0.01 ± 0 | 0.01 ± 0.01 |
| C 18:0 | 0.33 ± 0.02 | 0.32 ± 0.02 | 0.3 ± 0.02 | 0.31 ± 0.01 |
| C 18:1n-9 | 2.07 ± 0.07 | 1.96 ± 0.14 | 2.16 ± 0.15 | 2.01 ± 0.06 |
| C 18:1n-7 | 0.06 ± 0 | 0.05 ± 0.01 | 0.04 ± 0.01 | 0.05 ± 0.01 |
| C 18:2n-6 | 1.45 ± 0.07 | 1.39 ± 0.1 | 1.53 ± 0.09 | 1.43 ± 0.03 |
| C 18:3n-3 | 4.04 ± 0.14 | 3.89 ± 0.3 | 4.48 ± 0.22 | 4.05 ± 0.11 |
| C 20:0 | 0.03 ± 0.01 | 0.02 ± 0.0 | 0.01 ± 0 | 0.02 ± 0 |
| C 20:1n-9 | 0.03 ± 0.01 | 0.02 ± 0.0 | 0.02 ± 0 | 0.02 ± 0 |
| C 22:0 | 0.03 ± 0.01 | 0.02 ± 0.0 | 0.01 ± 0 | 0.02 ± 0 |
| C 24:0 | 0.03 ± 0.01 | 0.01 ± 0.0 | 0.01 ± 0 | 0.02 ± 0 |
| Total | 8.62 ± 0.31 | 8.2 ± 0.6 | 9.08 ± 0.51 | 8.44 ± 0.2 |

Fatty acid composition, as expressed as the percentage of total fatty acids, is shown in Table 4-B. The various different methods had significantly different results. The results from the isopropanol/hexane/heat/sonication method were no better or worse than any of the other, established methods for lipid extraction.

TABLE 4-B
Qualitative fatty acid profiles of flaxseed, expressed as percent composition
fo total fatty acids, following extraction with Folch, AOAC, ISO, Folch and novel
ultrasound (US) and heat (H) method.

| | | | | US (20 min) + H |
|---|---|---|---|---|
| Name | Folch 24 hr | AOAC | ISO | (15 min) |
| C 14:0 | 0.14 ± 0.03 | 0.19 ± 0.02 | 0.06 ± 0.01 | 0.16 ± 0.05 |
| C 16:0 | 5.77 ± 0.1 | 5.94 ± 0.16 | 5.48 ± 0.06 | 5.55 ± 0.07 |
| C 16:1 | 0.2 ± 0.12 | 0.24 ± 0.07 | 0.12 ± 0.01 | 0.16 ± 0.07 |
| C 18:0 | 3.73 ± 0.1 | 3.8 ± 0.17 | 3.27 ± 0.09 | 3.59 ± 0.09 |
| C 18:1n-9 | 23.67 ± 0.28 | 23.72 ± 0.21 | 23.43 ± 0.37 | 23.4 ± 0.37 |
| C 18:1n-7 | 0.67 ± 0.05 | 0.62 ± 0.07 | 0.48 ± 0.09 | 0.6 ± 0.15 |
| C 18:2n-6 | 16.57 ± 0.3 | 16.71 ± 0.22 | 16.69 ± 0.08 | 16.66 ± 0.11 |
| C 18:3n-3 | 46.15 ± 0.32 | 46.64 ± 0.35 | 48.7 ± 0.62 | 47.27 ± 0.45 |
| C 20:0 | 0.29 ± 0.06 | 0.27 ± 0.07 | 0.14 ± 0.01 | 0.21 ± 0.05 |
| C 20:1n-9 | 0.36 ± 0.13 | 0.23 ± 0.05 | 0.17 ± 0.02 | 0.24 ± 0.03 |
| C 22:0 | 0.32 ± 0.06 | 0.29 ± 0.05 | 0.16 ± 0.01 | 0.22 ± 0.02 |
| C 24:0 | 0.38 ± 0.1 | 0.29 ± 0.09 | 0.11 ± 0.01 | 0.2 ± 0.04 |
| Total | 98.54 ± 0.48 | 99.22 ± 0.37 | 98.8 ± 0.41 | 98.45 ± 0.63 |

Fatty acid determinations by the newly invented method of isopropanol:hexane extraction using heat and ultrasound are more accurate and comparable to the Folch, conventional AOAC and modified AOAC methods. The fatty acid determinations by the newly invented method were significantly better and more consistent than the ISO method.

The inventors have discovered that ultrasound and heat can dramatically increase lipid extraction throughput. Medium intensities of ultrasound for the specified duration of time, plus heat for the specified duration of time, increased lipid recoveries in all solvents. However, lipid dry weight recoveries and fatty acid determinations showed that ultrasound and heat-assisted extractions in hexane:isopropanol were much more advantageous than the other solvents tried, and duplicated standard procedures, such as the Folch protocol. 3:2 hexane:isopropanol, heat, and sonication, resulted in lipid extractions and fatty acid determinations that were equivalent, both quantitatively and qualitatively, to the standard Folch methodology, with a dramatic decrease in time and expense required to perform the extraction. The use of hexane:isopropanol also has a significant advantage over chloroform:methanol of the Folch procedure in that it is much less toxic; handling of extracts is therefore improved.

The hexane:isopropanol, heat and sonication method also resulted in levels of oxidation on the scale of the standard 24-h Folch extraction. In contrast, use of diethyl ether:petroleum ether resulted in significantly higher levels of malonaldehyde.

### Example 3

### Testing the Ultrasound-Heat Method on Food Homogenate and Brain Tissue

The ultrasound-heat extraction method described in example 2 was tested on a food homogenate samples comprising typical food consumed by Canadians. Healthy volunteers within the Kitchner-Waterloo area provided the lab with foods that they consumed over a 3-day period. They were reimbursed for their purchases. The food samples were then blended to yield a food homogenate reflecting their overall dietary intake. The analyses was subsequently performed on the food homogenate. As shown in Tables 5-A and 5-B, the application of ultrasound and heat to the hexane/isopropanol extract resulted in similar qualitative and quantitative fatty acid values, respectively, as compared to standard techniques.

Similarly, the method was attempted on rat brain samples. Rat brain contains a lot of long-chain polyunsaturated fatty acids such as arachidonic and docosahexaenoic acids. As shown in Tables 5-C and 5-D, the combined ultrasound-heat method yielded similar qualitative and quantitative values, respectively, as compared to the standard Folch method.

TABLE 5-A
Qualitative fatty acid profiles of a food homgenate, expressed as percent
composition of total fatty acids, following extraction with 24-hour Folch,
ultrasound (US) and heat (H) for 10 and 15 min respectively, or US and
H for 5 minutes each.

| Relative Percent (%) | | | |
|---|---|---|---|
| | Folch (24 | US (10 min) + | US (5 min) + H |
| Name | Hour) | H (15 min) | (5 min) |
| C 12:0 | 0.45 ± 0.02 | 0.28 ± 0.04 | 0.33 ± 0.05 |
| C 14:0 | 2.55 ± 0.07 | 2.41 ± 0.03 | 2.38 ± 0.05 |
| C 14:1 | 0.3 ± 0.04 | 0.23 ± 0.03 | 0.2 ± 0.02 |
| C 16:0 | 15.02 ± 0.29 | 14.46 ± 0.17 | 14.41 ± 0.1 |
| C 16:1 | 1.33 ± 0.68 | 1.67 ± 0.04 | 1.6 ± 0.05 |
| C 17:0 | 0.34 ± 0.15 | 0.27 ± 0.04 | 0.3 ± 0.03 |
| C 18:0 | 5.7 ± 0.37 | 5.23 ± 0.06 | 5.42 ± 0.09 |
| C 18:1n-9 | 39.25 ± 0.48 | 40.31 ± 0.51 | 39.9 ± 0.17 |
| C 18:1n-7 | 1.68 ± 0.1 | 1.53 ± 0.06 | 1.57 ± 0.05 |
| C 18:2n-6 | 18.81 ± 0.21 | 18.22 ± 0.06 | 17.75 ± 0.09 |
| C 18:3n-3 | 3.49 ± 0.02 | 3.51 ± 0.13 | 3.42 ± 0.07 |
| C 20:0 | 0.5 ± 0.1 | 0.53 ± 0.02 | 0.53 ± 0.01 |
| C 20:1n-9 | 0.93 ± 0.07 | 1.02 ± 0.07 | 1.05 ± 0.08 |
| C 20:2n-6 | 0.23 ± 0.06 | 0.19 ± 0.03 | 0.21 ± 0.02 |
| C 20:3n-6 | 0.16 ± 0.02 | 0.1 ± 0.02 | 0.12 ± 0.02 |
| C 20:4n-6 | 0.55 ± 0.04 | 0.4 ± 0.04 | 0.44 ± 0.04 |
| C 20:5n-3 | 1.29 ± 0.04 | 1.15 ± 0.05 | 1.12 ± 0.04 |
| C 22:0 | 0.7 ± 0.08 | 0.72 ± 0.14 | 0.85 ± 0.04 |
| C 22:1n-9 | 0.3 ± 0.03 | 0.21 ± 0.02 | 0.23 ± 0.03 |
| C 22:5n-3 | 0.48 ± 0.02 | 0.5 ± 0.04 | 0.39 ± 0.03 |
| C 24:0 | 0.35 ± 0.06 | 0.37 ± 0.02 | 0.41 ± 0.02 |
| C 22:6n-3 | 1.44 ± 0.08 | 1.27 ± 0.09 | 1.32 ± 0.13 |
| C 24:1n-9 | 0.24 ± 0.08 | 0.21 ± 0.04 | 0.25 ± 0.07 |
| Total | 96.08 ± 0.76 | 94.79 ± 0.76 | 94.19 ± 0.4 |

TABLE 5-B
Quantitative fatty acid profiles of a food homogenate, expressed as
mg per g of food homogenate, following extraction with 24-hour Folch,
ultrasound (US) and heat (H) for 10 and 15 min respectively, or US and
H for 5 minutes each.

| Concentration (mg/g of food homog.) | | | |
|---|---|---|---|
| | | US (10 min) + | |
| Name | 24 Hour | H (15 min) | US (5 min) + H (5 min) |
| C 12:0 | 0.11 ± 0.02 | 0.08 ± 0.01 | 0.09 ± 0.01 |
| C 14:0 | 0.65 ± 0.09 | 0.7 ± 0.02 | 0.69 ± 0.04 |
| C 14:1 | 0.08 ± 0.02 | 0.07 ± 0.01 | 0.06 ± 0.01 |
| C 16:0 | 3.8 ± 0.56 | 4.2 ± 0.09 | 4.18 ± 0.21 |
| C 16:1 | 0.34 ± 0.19 | 0.49 ± 0.02 | 0.46 ± 0.03 |
| C 17:0 | 0.09 ± 0.05 | 0.08 ± 0.01 | 0.09 ± 0.01 |
| C 18:0 | 1.45 ± 0.29 | 1.52 ± 0.03 | 1.57 ± 0.07 |
| C 18:1n-9 | 9.96 ± 1.58 | 11.72 ± 0.27 | 11.58 ± 0.52 |
| C 18:1n-7 | 0.43 ± 0.08 | 0.45 ± 0.02 | 0.46 ± 0.02 |
| C 18:2n-6 | 4.76 ± 0.7 | 5.3 ± 0.09 | 5.15 ± 0.22 |
| C 18:3n-3 | 0.89 ± 0.14 | 1.02 ± 0.05 | 0.99 ± 0.06 |
| C 20:0 | 0.13 ± 0.04 | 0.16 ± 0.01 | 0.15 ± 0.01 |
| C 20:1n-9 | 0.24 ± 0.05 | 0.3 ± 0.02 | 0.3 ± 0.03 |
| C 20:2n-6 | 0.06 ± 0.02 | 0.05 ± 0.01 | 0.06 ± 0.01 |
| C 20:3n-6 | 0.04 ± 0.01 | 0.03 ± 0.01 | 0.04 ± 0.01 |
| C 20:4n-6 | 0.14 ± 0.03 | 0.12 ± 0.01 | 0.13 ± 0.01 |
| C 20:5n-3 | 0.33 ± 0.04 | 0.33 ± 0.01 | 0.32 ± 0.02 |
| C 22:0 | 0.18 ± 0.05 | 0.21 ± 0.04 | 0.25 ± 0.02 |
| C 22:1n-9 | 0.08 ± 0.01 | 0.06 ± 0.01 | 0.07 ± 0.01 |
| C 22:5n-3 | 0.12 ± 0.02 | 0.15 ± 0.01 | 0.11 ± 0.01 |
| C 24:0 | 0.09 ± 0.03 | 0.11 ± 0 | 0.12 ± 0 |
| C 22:6n-3 | 0.36 ± 0.05 | 0.37 ± 0.02 | 0.38 ± 0.03 |
| C 24:1n-9 | 0.06 ± 0.03 | 0.06 ± 0.01 | 0.07 ± 0.02 |
| Total | 24.38 ± 3.96 | 27.56 ± 0.52 | 27.34 ± 1.24 |

TABLE 5-C
Qualitative fatty acid profiles of rat brain, expressed as percent
composition of total fatty acids, following extraction with 24-hour
Folch or ultrasound (US) and heat (H) for 10 and 15 min respectively.

| | | US for |
|---|---|---|
| Relative % composition | | 10 min the H |
| | Folch method | for 15 min |
| C 12:0 | 0.25 ± 0.11 | 0.28 ± 0.05 |
| C 14:0 | 1.88 ± 0.17 | 1.82 ± 0.5 |
| C 16:0 | 18.1 ± 0.43 | 16.79 ± 2.98 |
| C 16:1 | 0.28 ± 0.06 | 0.28 ± 0.05 |
| C 17:0 | 3.78 ± 0.09 | 2.86 ± 0.86 |
| C 18:0 | 20.31 ± 0.4 | 18.7 ± 1.93 |
| C 18:1n-9 | 15.4 ± 0.66 | 17.04 ± 3.58 |
| C 18:2n-6 | 2.82 ± 0.21 | 3.32 ± 0.89 |
| C 18:3n-3 | 1.09 ± 0.23 | 0.97 ± 0.23 |
| C 20:0 | 0.54 ± 0.29 | 0.59 ± 0.35 |
| C 20:1n-9 | 1.09 ± 0.25 | 1.88 ± 1.9 |
| C 20:2n-6 | 0.17 ± 0.07 | 0.2 ± 0.08 |
| C 20:3n-6 | 0.34 ± 0.04 | 0.34 ± 0.01 |
| C 20:4n-6 | 10.06 ± 0.68 | 8.88 ± 1.68 |
| C 20:5n-3 | 0.44 ± 0.09 | 0.47 ± 0.36 |
| C 22:0 | 0.27 ± 0.08 | 0.5 ± 0.2 |
| C 22:1n-9 | 2.78 ± 0.43 | 2.81 ± 0.38 |
| C 22:5n-3 | 0.31 ± 0.08 | 0.34 ± 0.14 |
| C 24:0 | 0.82 ± 0.13 | 1.01 ± 0.67 |
| C 22:6n-3 | 12.87 ± 0.59 | 11.43 ± 3.57 |
| C 24:1n-9 | 1.28 ± 0.12 | 1.91 ± 1.57 |
| Total | 94.88 ± 0.32 | 92.45 ± 1.09* |

TABLE 5-D
Quantitative fatty acid profiles of rat brain, expressed as mg per g
of brain, following extraction with 24-hour Folch or ultrasound (US)
and heat (H) for 10 and 15 min respectively.

| Concentration | | |
|---|---|---|
| (mg/g of rat brain) | | US for 10 min |
| | Folch method | the H for 15 min |
| C 12:0 | 0.07 ± 0.03 | 0.08 ± 0.02 |
| C 14:0 | 0.53 ± 0.07 | 0.55 ± 0.25 |
| C 16:0 | 5.06 ± 0.52 | 4.91 ± 0.54 |
| C 16:1 | 0.08 ± 0.02 | 0.08 ± 0.03 |
| C 17:0 | 1.06 ± 0.15 | 0.88 ± 0.42 |
| C 18:0 | 5.68 ± 0.6 | 5.56 ± 0.96 |
| C 18:1n-9 | 4.32 ± 0.67 | 5.33 ± 2.37 |
| C 18:2n-6 | 0.79 ± 0.14 | 1.04 ± 0.53 |
| C 18:3n-3 | 0.31 ± 0.07 | 0.28 ± 0.03 |
| C 20:0 | 0.15 ± 0.08 | 0.19 ± 0.16 |
| C 20:1n-9 | 0.31 ± 0.11 | 0.66 ± 0.79 |
| C 20:2n-6 | 0.05 ± 0.02 | 0.06 ± 0.03 |
| C 20:3n-6 | 0.09 ± 0.01 | 0.1 ± 0.03 |
| C 20:4n-6 | 2.8 ± 0.13 | 2.61 ± 0.47 |
| C 20:5n-3 | 0.12 ± 0.03 | 0.16 ± 0.16 |
| C 22:0 | 0.08 ± 0.03 | 0.16 ± 0.1 |
| C 22:1n-9 | 0.77 ± 0.06 | 0.86 ± 0.24 |
| C 22:5n-3 | 0.09 ± 0.02 | 0.11 ± 0.07 |
| C 24:0 | 0.23 ± 0.05 | 0.34 ± 0.29 |
| C 22:6n-3 | 3.61 ± 0.55 | 3.26 ± 0.56 |
| C 24:1n-9 | 0.36 ± 0.08 | 0.65 ± 0.68 |
| Total | 26.57 ± 3.05 | 27.88 ± 6.82 |

### Example 4

### Testing the Ultrasound-Heat Method on Other Nutrients

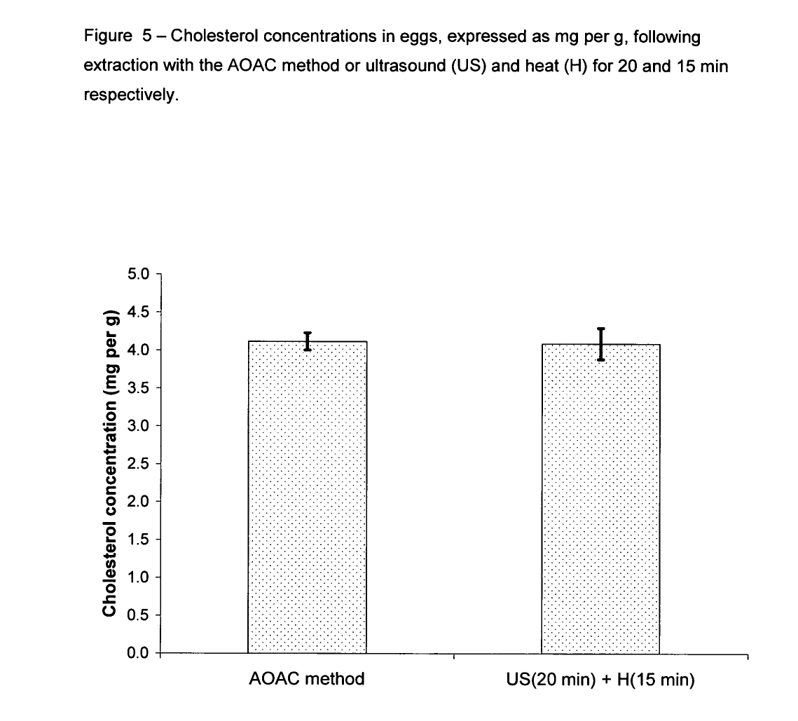

The applicability of the combined ultrasound-heat extraction method using hexane:isopropanol as a solvent was tested on eggs, which contain a lot of cholesterol. As shown in FIG. 5, hexane:isopropanol, heat and sonication method resulted in similar cholesterol levels as the standard AOAC method that is specific to cholesterol extraction.

### Example 5

### Testing the Ultrasound-Heat Method on Drugs

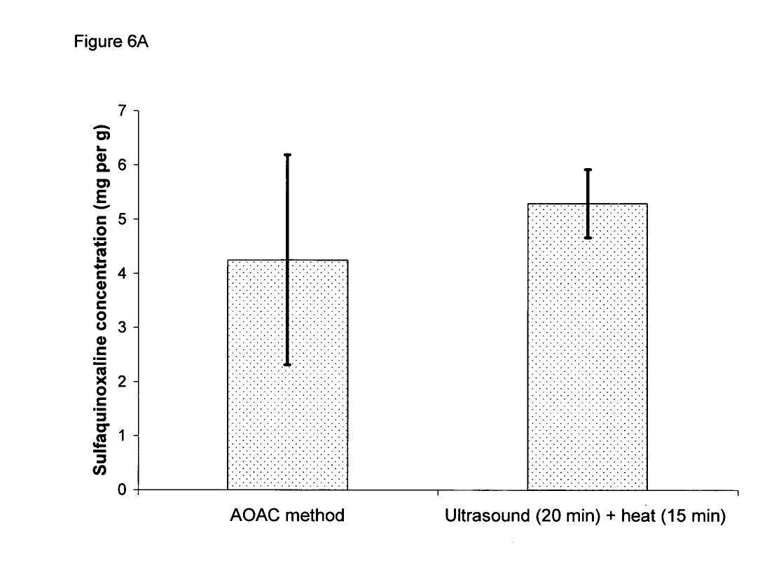

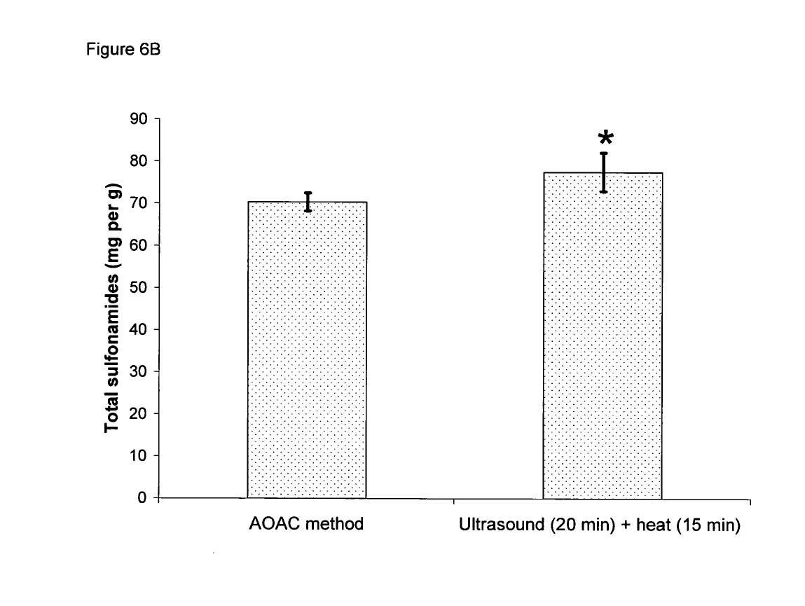

The applicability of the combined ultrasound-heat extraction method in hexane:isopropanol on drug extractions was confirmed on shrimp samples that have been spiked with sulfonamides. Sulfonamides are a class of antibiotics that are sometimes used in fish farming to prevent bacterial contamination of waters. However, they pose a health hazard to humans. The data for sulfaquinoxaline, a type of sulfonamide, and total sulfonamides are presented in FIGS. 6A and 6B, respectively. The ultrasound-heat method resulted in greater yields of sulfaquinoxaline and total sulfonamides, as compared to the standard AOAC method. Statistical analysis by unpaired t-test showed that the differences between the standard and ultrasound-heat method was significant for total sulfonamides (P<0.05), but not for sulfaquinoxaline.
¹ (AOAC Official Method 996.06 (2005) Official Methods of Analysis of AOAC International, 18^{th} ed. AOAC International, Gaithersburg
² Luque-Garcia J L, Luque de Castro M D (2004) Ultrasound-assisted soxhlet extraction: an expeditive approach for solid sample treatment. Application to the extraction of total fat from oleaginous seeds. J. Chromatogr A 1034:237-242)
³ Folch J, Lees M, Sloane S G H. A simple method for the isolation and purification of total lipids from animal tissues J. Biol. Chem 1957, 226 (1), 497-509.
⁴ Ahn Y G, Shin J H, Kim H Y, Khim J, Lee M K, Hong 3 (2007) Application of solid-phase extraction coupled with freezing-lipid filtration clean-up for the determination of endocrine-disrupting phenols in fish. Anal Chim Acta 603:67-75
⁵ Wu J, Lin L, Chau F T (2001) Ultrasound-assisted extraction of ginseng saponins from ginseng roots and cultured ginseng cells. Ultrason. Sonochem 8:347-352
⁶ Hemwimol S, Pavasant P, Shotipruk (2006) Ultrasound-assisted extraction of anthraquinones from roots of morinda citrifolia. Ultrason Sonochem 13:543-548
⁷ Christensen A, Ostman C, Westerholm R (2005) Ultrasound-assisted extraction and on-line LC-GC-MS for determination fo polycyclic aromatic hydrocarbons (PAH) in urban dust and diesel particulate matter. Anal Bioanal Chem 381:1206-1216
⁸ Richter P, Jimenez M, Salazar R, Marican A (2006) Ultrasound-assisted pressurized solvent extratction for aliphatic and polycyclic aromatic hydrocarbons from soils. 3. Chromatogr A, 1132:15-20.
⁹US patent publication 2006/0099693; 2006/0218668; 2005/0170479.
¹⁰ Ruiz-Jimines J, Priego-Capote F, Luque de Castro M D (2004) Identification and quantification of trans fatty acids in bakery products by gas chromatography-mass spectrometry after dynamic ultrasound-assisted extraction. J. Chromatogr A 1045:203-210
¹¹ Wei F, Gao G Z, Wang X F, Dong X Y, Li P P, Hua W, Wang X, Wu X M, Chen H (2008) Quantitative determination fo oil content in small quantity of oilseed rape by ultrasound-assisted extraction combined with gas chromatography. Ultrason Sonochem 15:938-942
¹² Cravotto G, Boffa L, Mantegna S, Perego P, Avogadro M, Cintas P (2008) Improved extraction of vegetable oils under high-intensity ultrasound and/or microwaves. Ultrason Sonochem 15:898-902.
¹³
¹⁴

1. A method for extracting nutrients toxins and/or drugs from a solid sample, comprising:
(a) adding a solvent to said sample, wherein said solvent is capable of solubilizing said nutrient toxin and/or drug;
(b) subjecting the sample and solvent to ultrasonic energy;
(c) subjecting the sample and solvent to heat;
(d) removing the solvent liquid fraction from what remains of the sample;
wherein the solvent liquid fraction contains the extracted lipids.

2. The method of claim 1 wherein the solvent is a mix of hexane and isopropanol.

3. The method of claim 1 further comprising (e) evaporating the solvent to isolate the extracted lipids.

4. The method of claim 1 wherein the sample is selected from the group consisting of a food item, a seed, a blood sample and a tissue sample.

5. The method of claim 1 wherein an order of steps is selected from the group consisting of (b) occurring before (c), (c) occurring before (b), and (b) and (c) occurring simultaneously.

6. The method of claim 1 wherein the lipid is one or more fatty acid.

7. The method of claim 6 wherein the fatty acid is selected from the group consisting of myristic acid, palmitic acid, palmitoleic acid, stearic acid, arachidic acid, betenic acid, oleic acid, linoleic acid, and alpha-linolenic acid.

8. The method of claim 1 further comprising the addition of a salt to said sample.

9. The method of claim 1 wherein the sample is subjected to ultrasonic energy for between 10 and 30 minutes, using an ultrasonic probe immersed in the solvent, said ultrasonic probe set at a medium intensity.

10. The method of claim 9 wherein the sample is subjected to ultrasonic energy for about 20 minutes.

11. The method of claim 9 wherein the medium intensity is between 20% and 80%.

12. The method of claim 9 wherein the medium frequency is about 60%.

13. The method of claim 1 wherein (c) comprises heating said sample to a temperature of between 85 and 115° C. for between 10 and 20 minutes.

14. The method of claim 13 wherein the sample is heated for about 15 minutes.

15. The method of claim 13 wherein the sample is heated to about 100° C.

16. The method of claim 1 wherein the sample is capped under nitrogen gas prior to heating.

17. A “one pot” method for extracting, derivatizing, and optionally isolating a fatty acid mixture from a sample, comprising:
(a) adding solvent to said sample, wherein said solvent is capable of solubilizing said lipid;
(b) subjecting the sample and solvent to ultrasonic energy;
(c) subjecting the sample and solvent to heat;
(d) derivatizing the fatty acid mixture now contained within the solvent fraction;
(e) removing the solvent liquid fraction, containing the extracted, derivatized fatty acid mixture, from what remains of the sample;
and optionally (f) evaporating the solvent to isolate the extracted, derivatized fatty acid mixture.

18. The method of claim 17 wherein the solvent is a mixture of hexane and isopropanol.

19. The method of claim 17 wherein the sample is selected from the group consisting of a food item, a seed, a blood sample and/or a tissue sample.

20. The method of claim 17 wherein an order of steps is selected from the group consisting of (b) occurring before (c), (c) occurring before (b), and (b) and (c) occurring simultaneously.

21. The method of claim 17 wherein the lipid is one or more fatty acid.

22. The method of claim 21 wherein the fatty acid is selected from the group consisting of myristic acid, palmitic acid, palmitoleic acid, stearic acid, arachidic acid, betenic acid, oleic acid, linoleic acid, and alpha-linolenic acid.

23. The method of claim 17 further comprising the addition of a salt to said sample.

24. The method of claim 17 wherein the sample is subjected to ultrasonic energy for between 10 and 30 minutes, using an ultrasonic probe immersed in the hexane and isopropanol, said ultrasonic probe set at a medium intensity.

25. The method of claim 24 wherein the sample is subjected to ultrasonic energy for about 20 minutes.

26. The method of claim 24 wherein the medium intensity is between 20% and 80%.

27. The method of claim 26 wherein the medium intensity is about 60%.

28. The method of claim 17 wherein step (c) comprises heating said sample to a temperature of between 85 and 115° C. for between 10 and 20 minutes.

29. The method of claim 28 wherein the sample is heated for about 15 minutes.

30. The method of claim 28 wherein the sample is heated to about 100° C.

31. The method of claim 17 wherein the sample is capped under nitrogen gas prior to heating.

32. Apparatus for the extraction of nutrients toxins and/or drugs from a sample, comprising:
(a) containing means for containing said sample;
(b) an ultrasonic probe, having two positions, a first position wherein the ultrasonic probe is outside of the containing means, a second position wherein the ultrasonic probe is within the containing means;
(c) a heating element capable of heating the containing means;
(d) a temperature sensor capable of (directly or indirectly) sensing the temperature within the containing means;
(e) a microprocessor controller coupled to the heating element, the ultrasonic probe, and the temperature sensor, and capable of controlling the duration and/or intensity of said ultrasonic probe and heating element; and
(f) a switch, toggle, or button for activating the microprocessor controller.

33. The apparatus of claim 32 wherein the containing means is capable of containing a disposable container containing said sample.

34. The apparatus of claim 32, further comprising:
(a) a fluid reservoir capable of containing isopropanol and hexane;
(b) a fluid pump coupled to said fluid reservoir, capable of transferring a fluid from said fluid reservoir to the containing means;
wherein the fluid pump is coupled to the microprocessor controller, and the microprocessor controller is capable of controlling the amount of fluid transferred from the fluid reservoir to the containing means.

35. The apparatus of claim 32, further comprising:
(a) a gas reservoir capable of containing compressed nitrogen gas, and capable of transferring a gas from said gas reservoir to the containing means;
(b) a gas flow control means for controlling gas flow from the gas reservoir to the containing means;
wherein the gas flow control means is coupled to the microprocessor controller, and the microprocessor controller is capable of controlling the amount of gas transferred from the gas reservoir to the containing means.

36. The apparatus of claim 32, further comprising:
(a) a gas inlet, capable of receiving a gas from an external compressed gas line;
(b) an internal gas line, linking said gas inlet to the containing means;
(c) a gas flow control means for controlling gas flow from the gas inlet to the containing means;
wherein the gas flow control means is coupled to the microprocessor controller, and the microprocessor controller is capable of controlling the amount of gas transferred from the gas inlet to the containing means.
